(19) United States
(12) Patent Application Publication
(10) Pub. No.: US 2023/0214180 A1
(43) Pub. Date: Jul. 6, 2023

(54) USING AND/OR REDUCE CARRY CHAINS ON PROGRAMMABLE HARDWARE

(71) Applicant: Microsoft Technology Licensing, LLC, Redmond, WA (US)

(72) Inventors: Skand HURKAT, Bellevue, WA (US); Aaron Michael LANDY, Kent, WA (US)

(21) Appl. No.: 17/740,831

(22) Filed: May 10, 2022

Related U.S. Application Data
(60) Provisional application No. 63/295,323, filed on Dec. 30, 2021.

(51) Int. Cl. G06F 7/50; G06F 1/03

(52) U.S. Cl. CPC G06F 7/50; G06F 1/03

(57) ABSTRACT

The present disclosure relates to a carry chain logic system that leverages carry in and carry out signals from logic blocks to implement logic functions on programmable hardware (e.g., FPGA hardware). In particular, implementations of the carry chain logic system facilitate implementation of logic gates (e.g., AND/OR gates) having high number of input signals without incurring routing delays caused by routing output signals between logic components implemented across different logic stages. For example, implementations described herein involve feeding carry out signals between adders of a logic chain across multiple logic components on a common logic stage, thus reducing routing penalties caused by routing signals via a routing fabric of the programmable hardware.

### CROSS-REFERENCE TO RELATED APPLICATIONS

This application claims the benefit of and priority to U.S. Provisional Application No. 63/295,323 filed Dec. 30, 2021, the entirety of which is incorporated herein by reference.

### BACKGROUND

Recent years have seen a rise in the use of programmable hardware to perform various computing tasks. Indeed, it is now common for many computing applications to make use of programmable arrays of blocks to perform various tasks. These programmable blocks of memory elements provide a useful alternative to application-specific integrated circuits having a more specialized or specific set of tasks. For example, field programmable gate arrays (FPGAs) provide programmable blocks that can be programmed individually and provide significant flexibility to perform various tasks.

As programmable hardware increases in size and complexity, it has become a challenge to implement configurations of hardware that provide fast and effective processing. For example, as logic functions are configured to accept an increasing number of input signals, conventional hardware units (e.g., logic modules) are often unable to produce outputs without causing some amount of delay. In many cases, these delays are unacceptable and potentially cause other logic modules to produce incorrect outputs. Furthermore, conventional approaches to fixing these delays are often complicated and difficult to implement on a given programmable hardware unit.

These and other problems exist with regard to implementing logic functions in on programmable hardware units, such as FPGAs.

### BRIEF DESCRIPTION OF THE DRAWINGS

FIG. 1A illustrates an example environment including an example carry chain logic system in accordance with one or more embodiments.

FIG. 1B illustrates an example logic chain implemented within the carry chain logic system in accordance with one or more embodiments.

FIG. 2 illustrates an example implementation of a logic unit implementable within a logic chain in accordance with one or more embodiments.

FIG. 3-1 illustrates a bit vector and an input vector in accordance with one or more embodiments.

FIG. 3-2 illustrates a generic carry chain in accordance with one or more embodiments.

FIG. 3-3 illustrates example implementation of an OR reduce logic chain.

FIG. 3-4 illustrates an example implementation of an AND reduce logic chain.

FIG. 4-1 through FIG. 4-3 illustrates other example implementations of logic chains, including an OR reduce logic chain and an AND reduce logic chain in accordance with one or more embodiments.

FIG. 5 illustrates another example implementation of an OR reduce logic chain and an AND reduce logic chain in accordance with one or more embodiments.

FIG. 6 illustrates an example configuration of logic functions implemented in combination with AND/OR reduce chain(s) in accordance with one or more embodiments.

FIG. 7 illustrates a flowchart of a method implemented on programmable hardware in accordance with one or more embodiments.

### DETAILED DESCRIPTION

The present disclosure relates to features and functionality of a carry chain logic system that leverages carry in and carry out signals from logic blocks to implement AND/OR logic functions on programmable hardware (e.g., FPGA hardware). In particular, embodiments of the carry chain logic system described herein enables implementation of large (e.g., high number of inputs) AND/OR logic gates within the framework of additional logic functions without incurring a significant delay as a result of routing inputs between multiple series of logic modules (e.g., multiple logic levels).

As an illustrative example, one or more embodiments of the carry chain logic system may involve a method or series of acts being implemented on a carry chain of logic modules that are implemented on programmable hardware. In accordance with one or more embodiments described herein, the carry chain logic system may receive an input vector including a plurality of input bits. The carry chain logic system may further receive a bit vector, separate from the input vector, including a plurality of vector bits. The carry chain logic system may cause an input bit to be an input to a first adder in the carry chain of logic modules. In some embodiments, the bit vector includes a primer bit (e.g., a least significant bit (LSB) of the bit vector) that is used as a first or primer input to the first adder to begin the logic chain. The carry chain logic system may then provide each vector bit and an associated bit from the plurality of inputs as inputs to additional adders in the carry chain. In one or more embodiments described herein, carry out signals from the adders can be provided as carry in signals to subsequent adders in the carry chain to generate an output based on a carry out signal from a last adder in the carry chain.

As another example, the carry chain logic system may include a carry chain logic function being implementable on programmable hardware. In accordance with one or more embodiments described herein, the carry chain logic system may include a first logic module having a first adder and a second adder, a second logic module having a third adder and a fourth adder, and any number of additional logic modules having additional adder components. In this example, the first logic module may be configured to receive, at a first adder, a first input and a primer bit of a bit vector to generate a carry out signal that is provided to the second adder. The first logic module may be further configured to receive, at a second adder, the carry out signal from the first adder in combination with a second input and an associated bit value from the bit vector to generate another carry out signal. The carry out signal(s) may be fed to additional adders on other logic modules in conjunction with addition inputs and additional bit values of bit vectors to implement a logic function in accordance with one or more embodiments described herein.

The present disclosure includes a number of practical applications that provide benefits and/or solve problems associated with configuring logic functions on programmable hardware. Examples of some of these benefits are discussed in further detail below.

For example, features of the carry chain logic system enable large input logic gates without incurring propagation delays as a result of multiple logic levels being coupled together in series on programmable hardware. For instance, conventional logic module configurations often involve logic modules that receive inputs and feed outputs from different logic levels in a typical hardware configuration. These additional logic levels result in longer propagation delays that require additional pipelining or a lower clock frequency.

The carry chain logic system additionally provides features that enable logic modules to be combined on the same logic level to create AND/OR logic of a higher number of inputs than any individual logic module(s). For example, a logic module may include hardware that limits a specific logic module to receive and process six inputs. Notwithstanding this limitation, the carry chain logic system utilizes carry in and carry out signals to increase the number of inputs that can be considered by a given logic gate without routing input and output signals between logic levels.

As a more specific example, where a lookup table (LUT) in a conventional logic module may only support a fixed number of inputs (e.g., six inputs), any operation such as an AND/OR reduce over more than six inputs may require multiple logic levels if implemented in the LUTs alone. As a result, implementing an operation that requires more than the fixed number of inputs that an LUT is preconfigured to receive may involve routing inputs between logic levels and incurring delays caused as a result of routing inputs via routing fabric of the programmable logic.

In one or more embodiments, the carry chain logic system improves upon this limitation of conventional systems by utilizing the carry in and carry out signals as inputs to additional logic functions (e.g., on a same logic level as the logic modules associated with the respective carry in and carry out functions). Indeed, as will be discussed in further detail herein, the carry chain logic system may decrease a reliance on input and output signals being routed via routing fabric of the programmable logic hardware. As routing inputs between logic levels can take 100s of picoseconds or even nanoseconds, this delay can cause logic functions to fail or require complicated pipeline configurations and/or lower clock cycles. Conversely, by utilizing the carry in and carry out signals as inputs (e.g., carry in signals) to logic modules on the same logic level, this delay can be significantly reduced and involve a much lower delay of only a few (e.g., 10) picoseconds.

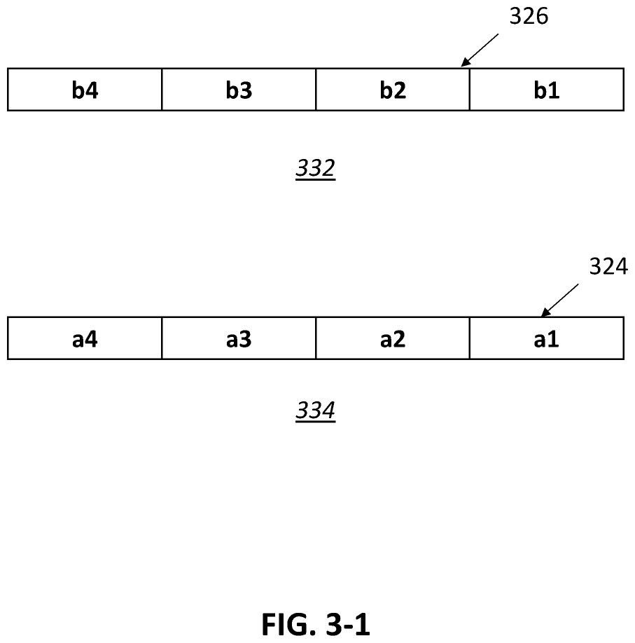

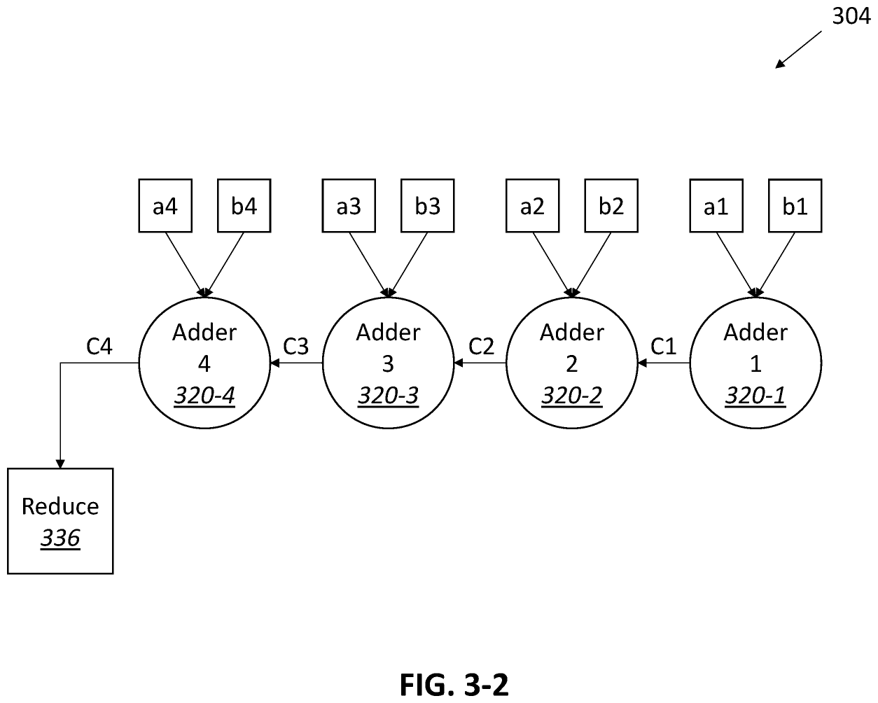

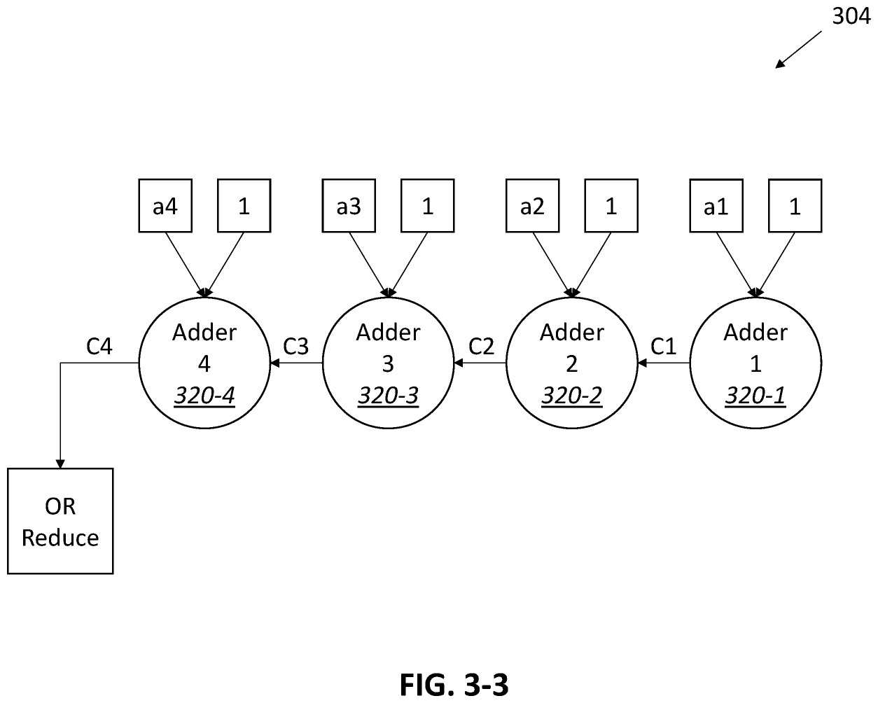

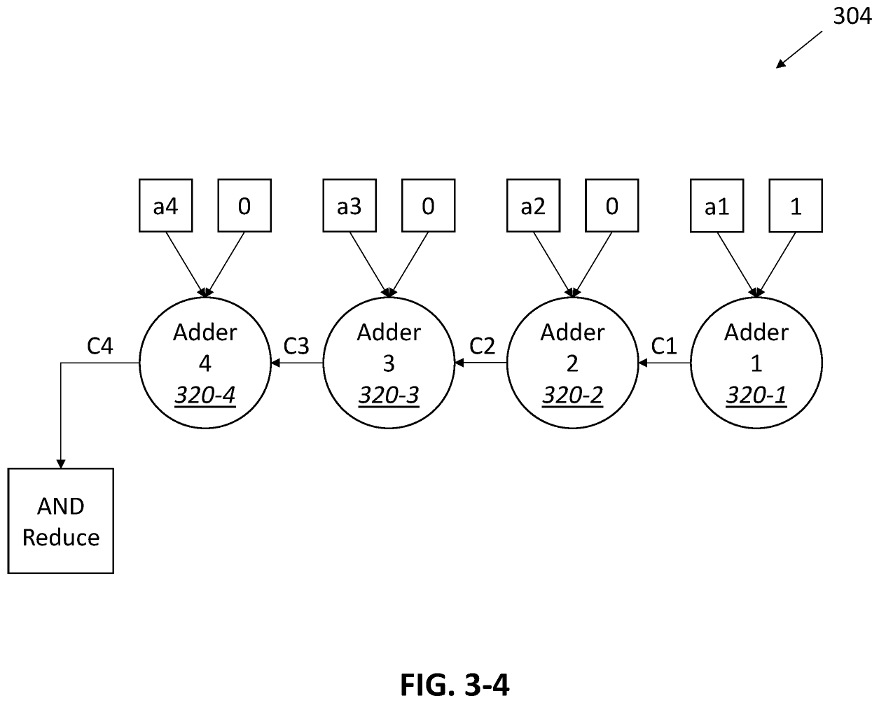

The features described herein can be implemented in a number of ways to provide additional benefits and optimizations within programmable hardware systems. For example, in one or more embodiments described herein, the carry chain logic system may treat an input to be reduced as a bit vector, which can be implemented within an OR reduce function by adding the input bit vector to a bit vector of all 1s. Similarly, by adding the input bit vector to a bit vector of 0s with a primer input of 1 in a least significant bit (LSB), a 1 may not be seen as the carry out signal unless all bits on the input are 1, which may provide an AND reduce operation. As carry chains produce faster signals than LUTs, this enables performance of reductions on a larger number of inputs using carry chains rather than LUTs. This example and additional variations will be discussed below in connection with FIGS. 3-5.

As illustrated in the foregoing discussion, the present disclosure utilizes a variety of terms to described features and advantages of the carry chain logic system. Additional detail will now be provided regarding the meaning of some of these terms.

As used herein, a “logic module” may refer to any discrete component of hardware capable of receiving a plurality of inputs and producing an output based on a logic function implemented thereon. In one or more embodiments, a logic module may include components such as LUTs, adders, registers, multiplexors, and routing components. In one or more embodiments described herein, a logic module refers that allows configuration of an N-input (e.g., 4 input, 6 input, 8 input) logic function from any of a number of manufacturers that can be implemented in combination with additional logic modules on a programmable hardware device. In one or more embodiments, a programmable hardware device (e.g., an FPGA device) has 100s, 1000s, or 1,000,000s of logic modules implemented thereon being programmable to implement a wide variety of functions.

As used herein, a “logic level” may refer to a grouping of one or more logic modules separated by another grouping of one or more logic modules via a routing fabric between the modules. For example, in one or more embodiments described herein, a logic level may refer to a carry chain of logic modules having carry signals fed as carry signal inputs between the logic modules. Logic modules of the logic level may provide output signals to additional logic layers directly or via registers capable of capturing data from one clock cycle to the next. In one or more embodiments described herein, a logic chain of logic modules may refer to logic modules within a common logic level. Conversely, a series of logic modules or logic module series may refer to logic modules that feed signals to one another across different logic levels (e.g., via a routing fabric).

As used herein, a bit vector may be a pre-determined vector or set of bit values that may be used as an input to one or more logic modules. The bit vector is composed of multiple vector bits. The bit values of the vector bits may be based on the type of logic function the carry chain logic system is performing. For example, and as will be discussed in further detail herein, a carry chain logic system that is configured to perform an OR reduction may include a bit vector having vector bits with bit values of one. In some examples, a carry chain logic system that is configured to perform an AND reduction may include a bit vector having vector bits with bit values of zero, and a first vector bit with a bit value of one.

In one or more implementations described herein, a first vector bit is referred to as a primer bit. As used herein, a primer bit may be an initial bit that may be added to the first logic module of the carry chain logic system. The primer bit may have a bit value that is based on the configuration of the carry chain logic system. For example, for an AND or an OR reduction, the primer bit may have a bit value of one to allow the first logic module to perform the AND or the OR reduction. In some embodiments, the primer bit may be included as a vector bit in the bit vector.

As used herein, an input vector may include a plurality of input bits for the carry chain logic system. Each logic module may receive an input bit from the input vector. As discussed in further detail herein, the input bits of the bit vector may be received from other functions in the programmable hardware. For example, the input bits may be outputs from a logic function on a different logic level than the carry chain logic system. In some examples, the input bits may be outputs from other logic functions, combinations, subtractions, or any other function performed on the programmable hardware. In some embodiments, the input vector has a quantity of input bits. The number of logic modules in the carry chain logic system may be equal to the quantity of input bits.

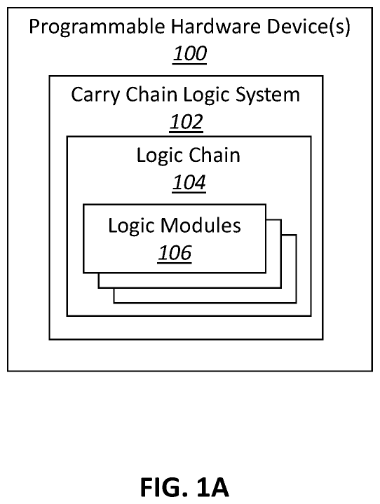

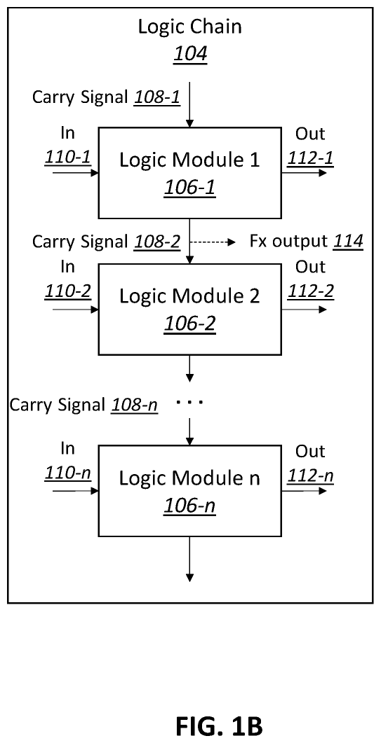

Additional detail will now be discussed regarding a carry chain logic system in relation to illustrative figures portraying example embodiments. For example, FIG. 1A illustrates an example environment showing a programmable hardware device(s) 100 having a carry chain logic system 102 implemented thereon. As shown in FIG. 1, the carry chain logic system 102 may include multiple logic chains 104, which may individually include any number of logic modules 106 chained together in accordance with one or more examples discussed herein. In one or more embodiments, the programmable hardware device refers to an FPGA device having any number of logic modules 106 implemented thereon.

FIG. 1B illustrates an example implementation of a logic chain 104 on the carry chain logic system 102 shown in FIG. 1B. The logic chain 104 may refer to any of the logic chains 104 on the carry chain logic system 102 implemented on the programmable hardware device(s) 100 shown in FIG. 1A.

As shown in FIG. 1B, the example logic chain 104 may include any number of logic modules (collectively 106) configured to receive an input (collectively 110) (e.g., multiple input signals) and generate an output (collectively 112) (e.g., one or multiple outputs). As further shown, the logic modules 106 may be configured to receive and provide a carry signal (collectively 108) between the respective logic modules 106.

As an example, and as shown in FIG. 1B, a first logic module 106-1 may receive a first input 110-1, a first carry signal 108-1, and produce a first output 112-1 and a second carry signal 108-2. The first input(s) 110-1 and/or the first carry signal 108-1 may be received from any source, such as an input vector or another logic module 106 (e.g., from a different logic stage). In some embodiments, the first output 112-1 may also be provided to another logic module. As will be discussed in further detail below, the logic modules 106 may additionally receive as input a bit vector with a first bit referring to a primer bit and additional bits that cause the logic modules 106 to simulate a particular logic gate.

As further shown, the logic modules 106 may receive and provide carry signals 108 between logic modules 106 of the logic chain 104. For example, each logic module 106 may receive a carry in signal and provide a carry out signal. As shown in FIG. 1B, a carry signal 1068 may refer to both a carry out signal for one logic module 106 and a carry in signal for another logic module 106. For example, the second carry signal 108-2 may be a carry out signal for the first logic module 106-1 and a carry in signal for the second logic module 106-2. In one or more embodiments described herein, the carry in signal is provided as an input for a logic module 106 within the same or different logic chain 104.

As shown in FIG. 1B, while each of the carry signals 108 may feed as a carry input to another logic module 106, one or more embodiments may involve the carry signal being used as an input to another logic function. For example, in one or more embodiments described herein, the carry signal 108 may serve as an AND/OR reduce function output 114 to expand a number of inputs of a logic gate implemented by the logic chain. In one or more embodiments, the carry signal 108 may be fed as an input to another logic function altogether. Additional examples will be discussed in connection with FIGS. 3-5.

As discussed herein, the logic chain 104 may be of any length, with the carry signal 108 being propagated through any number of logic modules 106. For example, the logic chain 104 shown in FIG. 1B has a first logic module 106-1, receiving a first carry signal 108-1 and a first input 110-1. The first input 110-1 may include a first vector bit from a bit vector and a first input bit from an input vector. Thus, the first logic module 106-1 may receive three inputs. The first logic module 106-1 may generate a first output 112-1 and a second carry signal 108-2 (e.g., the carry out signal for the first logic module 106-1). In some embodiments, the second carry signal 108-2 may be the LSB of the results of the first logic module 106-1 and the first output 112-1 may be the MSB of the results.

The second logic module 106-2 may receive as inputs the second carry signal 108-2 (e.g., the carry in signal) and a second input 110-2. The second input 110-2 may include a second vector bit from the bit vector and a second input from the input vector. Thus, the second logic module 106-2 may receive three inputs. The second logic module 106-2 may generate a second output 112-2 and a carry signal 108. The logic chain 104 may be continued indefinitely, producing n number of carry signals 108-n. N number of logic modules 106-n may receive the n-carry signals 108-n, n-inputs 110-n, and n-outputs 112-n. This may allow for long logic chains 104 to process large amounts of inputs on the same logic level with reduced processing delays.

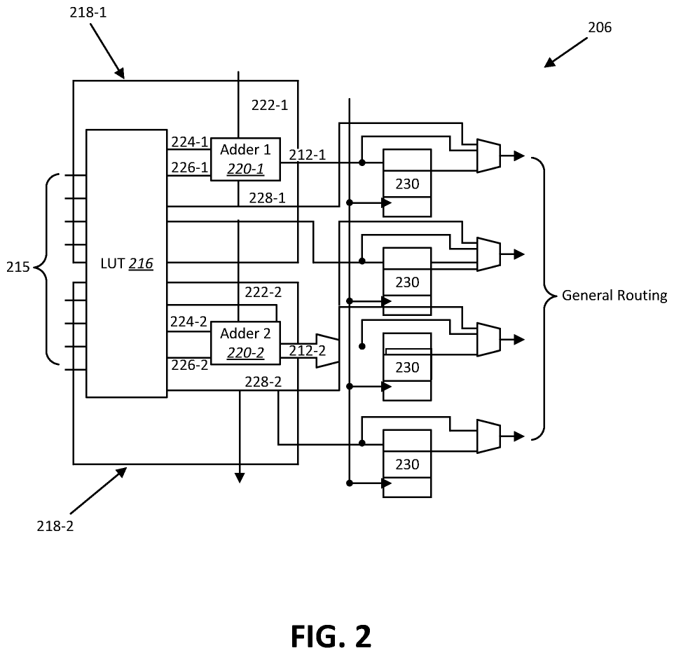

FIG. 2 illustrates a more detailed implementation of an example logic module in accordance with one or more embodiments. As shown in FIG. 2, the logic module may include a variety of components being configurable to provide a logic gate for a predetermined number of inputs. In the example shown in FIG. 2, the logic module can be configured to process up to eight inputs.

As shown in FIG. 2, a logic module 206 may include a look up table (LUT) being programmable to provide any of a variety of Boolean functions for N-number of inputs up to the limit of the logic module. As shown in FIG. 2, the logic module 206 may include two logic portions (collectively 218), including a first logic portion 218-1 and a second logic portion 218-2. Each logic portion 218 may utilize the LUT 216 to process a four-input LUT table function. In this manner, two four-input LUT functions may process the respective groupings of inputs and generate two outputs.

As shown in FIG. 2, the outputs may be fed from the LUT 216 to two separate logic modules. In the embodiment shown, the logic modules are adders (collectively 220) which may be used to add the two bits. The adders 220 may be one-bit adders, and configured to process three one-bit inputs, including a carry in bit 222, an input bit 224, and a vector bit 226. The adders 220 may process the carry in bit 222, the input bit 224, and the vector bit 226 to produce an output (collectively 212) and a carry out bit (collectively 228). The output 212 may be passed to a register 230, where it may be routed to a different logic level or other portion of the programmable hardware device. The carry out bit 228 may be used as a carry in bit 222 for another adder in the logic chain.

In the embodiment shown, the logic module 206 may receive six LUT inputs 215 at the LUT 216. In the first logic portion 218-1, the LUT 216 may output a first input 224-1 to the first adder 220-1 and provide the first adder 220-1 with a first vector bit 226-1. The first adder 220-1 may receive a first carry in bit 222-1. The first adder 220-1 may process the first carry in bit 222-1, the first input 224-1, and the first vector bit 226-1 and generate a first output 212-1 and a first carry out bit 228-1.

In the second logic portion 218-2, the LUT 216 may generate a second input 224-2. The LUT 216 may provide the second adder 220-2 with the second input 224-2 and a second vector bit 226-2. The second adder 220-2 may receive the first carry out bit 228-1 as a second carry in bit 222-2. The second adder 220-2 may process the second carry in bit 222-2, the second input 224-2, and the second vector bit 226-2 to generate a second output 212-2 and a second carry out bit 228-2. The second carry out bit 228-2 may be used at another logic module 206 on the same logic level as a carry in bit 222.

In one or more embodiments described herein, the logic module 206 may be configured as an AND gate or and OR gate and be configured to add inputs from the respective logic portions of the logic module.

As shown in FIG. 2, the logic module 206 may include a plurality of registers 230. As mentioned above, the registers 230 can capture data from clock cycle to the next clock cycle. In one or more embodiments, the logic module 206 may be configured to use the registers 230 to achieve a higher frequency than would be possible bypassing the adders 220 and/or registers 230.

As will be discussed in connection with multiple examples below, the logic module 206 may be combined with one or more additional logic modules 206 to create a logic gate having a greater number of inputs than are available for a single logic module 206. For example, the logic module 206 may be combined with a plurality of additional logic modules 206 to provide a large AND gate having a significantly higher number of inputs that would be available in conventional configurations (e.g., thirty, fifty, or hundreds of inputs).

In one or more embodiments described herein, the logic module 206 may implement the larger logic gate by implementing a logic chain having a plurality of logic modules 206 that are configured to receive a bit vector, an input vector, and carry signal(s). In particular, the bit vector may include a vector of 1s and/or 0s in addition to a primer bit fed to a first logic module 206 of plurality of logic modules 206 in the logic chain. The bit vector may be fed as inputs to the logic modules 206 of the logic chain together with an input vector of input bits for which the logic gate is to be applied.

In addition to the bit vector and input vector being provided as inputs, the logic modules 206 may use the carry inputs fed to the adders to create a ripple adder and produce two bit values having a most significant bit (MSB) and a least significant bit (LSB) based on a combination of a relevant bit vector value, input value, and carry signal provided to the adder(s). In one or more embodiments described herein, the MSB becomes the carry out bit for an adder or logic module while the LSB becomes the output for the respective adder or logic module.

It will be appreciated that the MSB and/or LSB may be used differently depending on the specific logic gate the logic modules are programmed to provide. In addition, the specific values of the bit vector, including the set of 0s and/or 1s as well as the primer bit may be determined to be specific values based on the logic gate that the logic modules have been programmed to provide.

Additional detail will now be discussed in connection with a number of example implementations. For example, FIG. 3 illustrates a first example OR-reduce logic chain and a first example AND-reduce logic chain.

FIG. 3-1 is a representation of a bit vector 332, including a plurality of vector bits 326 and an input vector 334 including a plurality of input bits 324. As an illustrative example, the bit vector 332 includes four vector bits 326, including b1, b2, b3, and b4, with b1 being referred to herein as a primer bit (Pr). The primer bit Pr may be the initial bit used in the first logic module of the logic chain. The input vector 334 includes four input bits, including a1, a2, a3, and a4.

FIG. 3-2 is a representation of a generic logic chain 304 including four adders (collectively 320), according to at least one embodiment of the present disclosure. A first adder 320-1 receives the primer bit Pr and a first input bit a1 from the input vector 334. The first adder outputs a first carry signal C1. A second adder 320-2 receives as inputs the first carry signal C1, a second vector bit b1 from the bit vector 332, and a second input bit a1 from the input vector 334. The second adder 320-2 may generate a second carry signal C2. In one or more embodiments, the first adder 320-1 and the second adder 320-2 may be part of a first logic module.

A third adder 320-3 may receive as inputs the second carry signal C2, a third vector bit b3 of the bit vector 332, and a third input bit a3 from the input vector 334. The third adder 320-3 may generate a third carry signal C3. A fourth adder 320-4 may receive as inputs the third carry signal C3, a fourth vector bit b4 of the bit vector 332, and a fourth input bit of the input vector 334. The fourth adder 320-4 may generate a fourth carry signal C4. The third adder 320-3 and the fourth adder 320-4 may be part of a second logic module. Thus, the implementation shown in FIG. 3-2 may represent two logic modules, each including two adders. Other implementations may include different groupings of adders and modules depending on unique hardware and specifications of the logic modules.

As shown in FIG. 3-2, a reduction output 336 may be provided as an output of the logic chain 304. A reduction output 336 may receive the fourth carry signal C4 and perform a reduction function on the fourth carry signal C4 and/or any other outputs of the logic chain 304. As discussed herein, because each of the adders 320 are on the same logic level, the reduction output 336 may be produced on the fourth carry signal C4 with fewer processing delays. As may be seen, the logic chain 304 may include more or fewer than four adders 320.

As shown in FIG. 3-3, an OR-reduce logic chain 304 includes four adders 320 that may be implemented within logic modules in accordance with one or more embodiments described herein. For instance, a first adder 320-1 and/or second adder 320-2 may be implemented within a similar logic module as discussed above in connection with FIG. 2. A third adder 320-3 and/or fourth adder 320-4 may be implemented within another logic module having similar features and functionality as discussed above in connection with FIG. 2.

As shown in FIG. 3-3, an input vector 334 having the values a1, a2, a3, and a4 may be provided as input to the logic modules. For instance, a1 and a2 may be provided as inputs to a first logic module while a3 and a4 may be provided as inputs to a second logic module. In combination with the input vector 334, a predefined bit vector 332 may be provided as inputs to the logic module. As shown in FIG. 3-3, the individual bits of the bit vector 332 may be provided to each of the adders in conjunction with a corresponding bit value of the input vector 334. By way of example, and as shown in FIG. 3, a first bit of the bit vector 332 may be provided as an input to a first adder 320-1 (e.g., on a first logic module) in conjunction with a1 while a second bit of the bit vector 332 may be provided as an input to a second adder 320-2 (e.g., on the first logic module) in conjunction with a2. In addition, a third bit of the bit vector 332 may be provided as an input to a third adder 320-3 (e.g., on a second logic module) in conjunction with a3 while a fourth bit of the bit vector 332 may be provided as an input to a fourth adder 320-4 (e.g., on the second logic module) in conjunction with a4. Other configurations may include any number of input bits and corresponding bit vector bits provided to additional adders on additional logic modules.

As mentioned above, the specific values of the bit vectors 332 may be determined based on the specific logic gate to be implemented by the logic modules of the logic chain 304. For example, in the illustrated configuration, the bit vector 332 may include a first primer input (e.g., a “1” bit value) provided to the first adder in combination with additional “1” inputs provided to the additional adders of the OR-reduce logic chain.

In the example shown in FIG. 3-3, the adders 320 will generate two bit outputs. If either of the input bits (e.g., the input bit and corresponding vector bit) are true, then the adder 320 would propagate the input carry. If both are true, then the adder 320 generates the output carry. In one or more embodiments, this configuration includes a ripple carry adder. In one or more embodiments, the LSBs can be ignored and the MSB are provided as carry in signals to a next adder in the OR-reduce logic chain. In one or more embodiments, the LSBs are provided as outputs to one or more additional logic functions on the programmable hardware device(s).

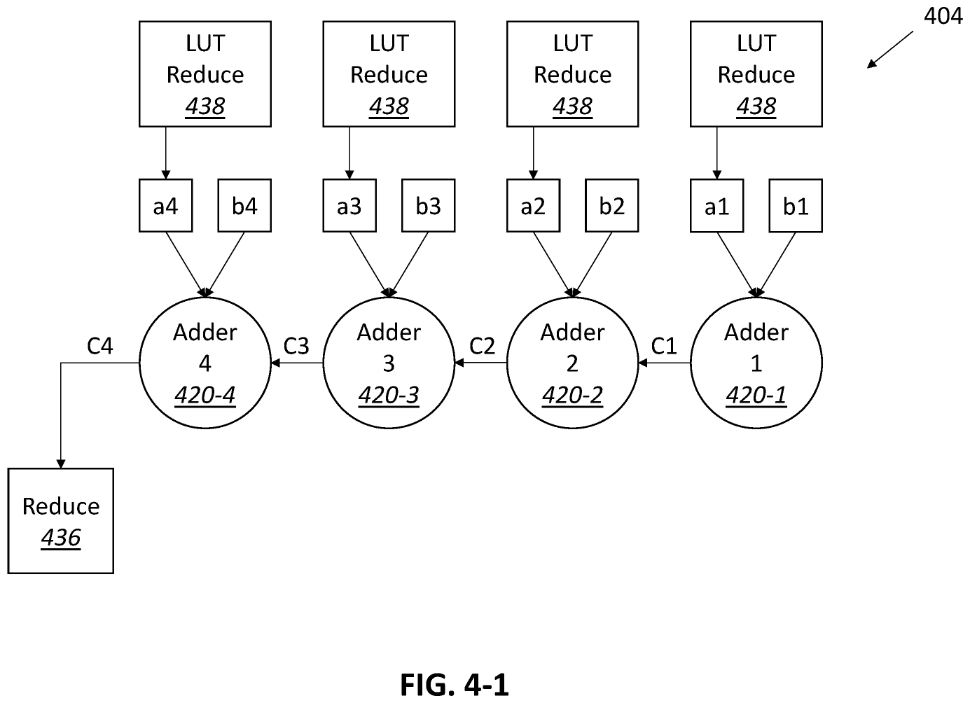

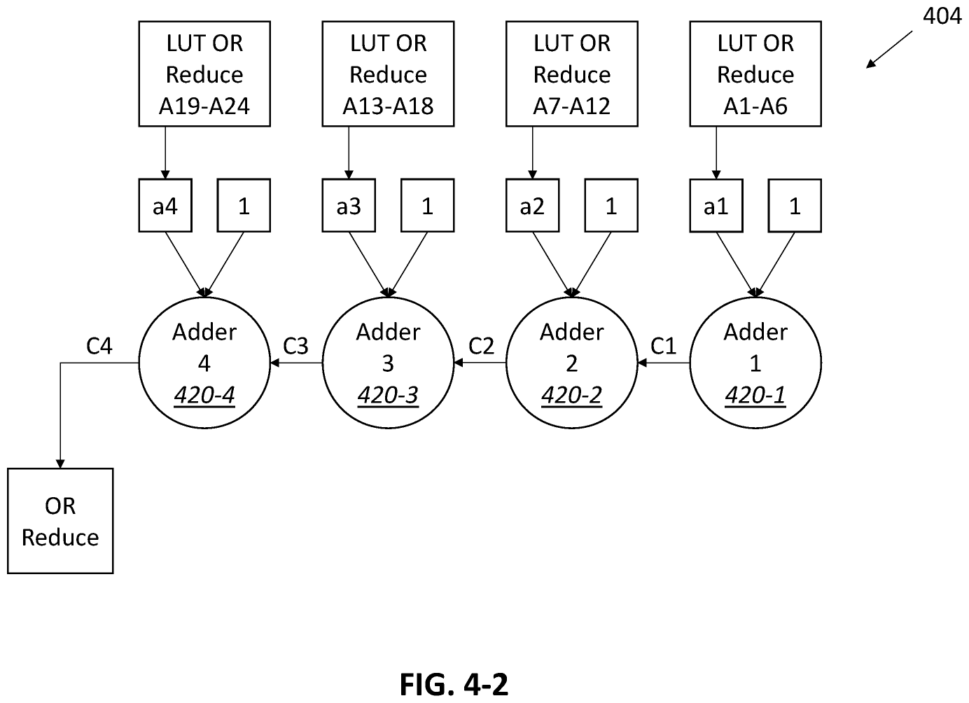

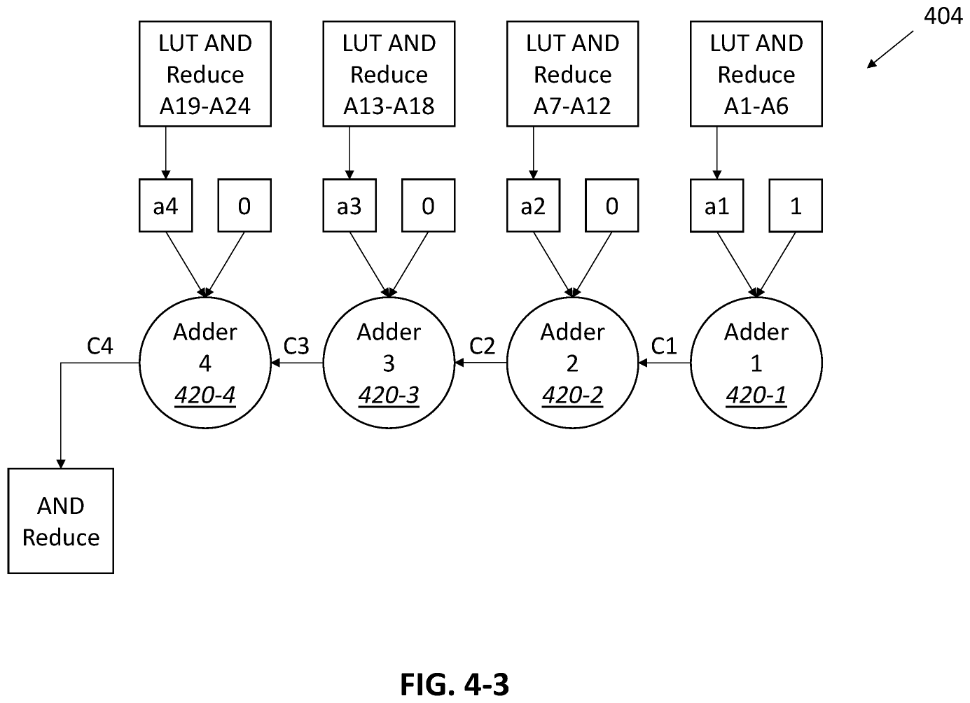

As mentioned above, FIG. 3-4 further shows an example AND-reduce logic chain 304. As shown in FIG. 3-4, the AND-reduce logic chain 304 includes four adders 320 similar to the four adders 320 described above in connection with the OR-reduce logic chain. These adders 320 may be implemented within logic modules similar to the OR-reduce logic chain. As further shown, the logic modules may receive an input vector 334 in combination with a bit vector 332 having specific values based on an intent to implement an AND gate functionality (as opposed to the OR gate). For example, in the example shown in FIG. 3, the bit vector 332 may include a vector of all “0” values with a first vector bit of “1”. Using similar logic as the adder components discussed above, the AND-reduce framework may generate the output of an AND gate for any number of inputs using a plurality of logic modules on the same logic chain of logic modules (e.g., on a common logic lane).

FIG. 4-1 illustrates an example implementation showing a variation of the example discussed above in connection with FIG. 3, according to at least one embodiment of the present disclosure. The example function described in FIG. 4-1 illustrates similar principles discussed in connection with similar components shown in FIG. 3. For example, FIG. 4-1 shows a generic logic chain 404 having a plurality of adders (collectively 420). Each adder 420 may receive a plurality of inputs, including a carry in signal, an input bit a1, a2, a3, a4, and a vector bit b1, b2, b3, b4, from a bit vector.

The input bit may include the output of an LUT reduce function 438. The LUT reduce function 438 may receive multiple bits and reduce the multiple inputs to a single input for the adder 420. For example, the LUT reduce function 438 may reduce six bits from a bit vector at a time to generate the various inputs a1, a2, a3, a4. In this manner, rather than each input from the bit vector be an individual input to an adder 420, the LUT reduction function 428 may perform an initial reduction of the input bits, thereby reducing the total number of logic modules that may be used when performing a given operation. The output of the adders 420 may then be used in a reduce output 436.

FIG. 4-2 illustrates an example OR-reduce logic function in a logic chain 404. The OR-reduce logic chain 404 may include a chain of adders 420 implemented within logic modules, which may include similar features as the logic module discussed above in connection with FIG. 2. In this example, each of the adders 420 may receive an input bit a1, a2, a3, a4, and a bit vector bit as well as a carry in value c1, c2, c3, c4, from another adder component.

In the example shown in FIG. 4-2, the input bits may refer to outputs from LUTs. More specifically, in one or more embodiments, LUTs may be used to reduce six bits of a bit vector at a time and use adder chains to reduce the results. Thus, rather than having a single input bit for each bit of the bit vector, the OR-reduce logic chain may make use of LUTs to reduce up to six bits (or other predetermined number of inputs based on capabilities of the logic modules) for each bit from the bit vector. This can significantly reduce the number of logic modules in a given carry chain when configuring a logic gate having a large number of inputs.

With reference to the specific example shown in FIG. 4-2, a first LUT OR reduce may reduce inputs A1 through A6 to generate the first input bit a1. A first adder 420-1 may receive the first input bit a1 and a vector bit (e.g., a primer bit) having a value of 1. The output of the first adder 420-1 may include a first carry bit C1.

A second LUT OR reduce may reduce inputs A7 through A12 to generate the second input bit a2. A second adder 420-2 may receive the second input bit a2, a bit vector having a value of 1, and the first carry bit C1. The output of the second adder 420-2 may include a second carry bit C2.

A third LUT OR reduce may reduce inputs A13 through A18 to generate the third input bit a3. A third adder 420-3 may receive the third input bit a3, a bit vector having a value of 1, and the second carry bit C2. The output of the third adder 420-3 may include a third carry bit C3.

A fourth LUT OR reduce may reduce inputs A19 through A24 to generate the fourth input bit a4. A fourth adder 420-4 may receive the third input bit a4, a bit vector having a value of 1, and the third carry bit C3. The output of the fourth adder 420-4 may include a fourth carry bit C4.

An OR reduce may receive the fourth carry bit C4 and perform an OR reduce. In this manner, the carry chain 404 may perform an OR reduce on a 24 bit input vector in a single logic level, thereby reducing the total number of logic modules used to perform the OR reduce and increasing the speed of the OR reduce.

FIG. 4-3 is a representation of an example AND-reduce carry chain 404 logic function in accordance with one or more embodiments described herein. Similar features to the OR-reduce logic chain 404 may be applied to the AND-reduce logic chain 404. For example, LUTs may be used to reduce bits of a bit vector having values that are specific to the AND gate logic. In this example, the four adders 420 may be used to process an AND-reduce gate for four LUTs that each receive up to six inputs (or other number of inputs based on the capabilities of the logic modules).

With reference to the specific example shown in FIG. 4-3, a first LUT AND reduce may reduce inputs A1 through A6 to generate the first input bit a1. A first adder 420-1 may receive the first input bit a1 and a bit vector having a value of 1 (e.g., the primer bit). The output of the first adder 420-1 may include a first carry bit C1.

A second LUT AND reduce may reduce inputs A7 through A12 to generate the second input bit a2. A second adder 420-2 may receive the second input bit a2, a bit vector having a value of 0, and the first carry bit C1. The output of the second adder 420-2 may include a second carry bit C2.

A third LUT AND reduce may reduce inputs A13 through A18 to generate the third input bit a3. A third adder 420-3 may receive the third input bit a3, a bit vector having a value of 0, and the second carry bit C2. The output of the third adder 420-3 may include a third carry bit C3.

A fourth LUT AND reduce may reduce inputs A19 through A24 to generate the fourth input bit a4. A fourth adder 420-4 may receive the third input bit a4, a bit vector having a value of 0, and the third carry bit C3. The output of the fourth adder 420-4 may include a fourth carry bit C4.

An OR reduce may receive the fourth carry bit C4 and perform an AND reduce. In this manner, the carry chain 404 may perform an AND reduce on a 24 bit input vector in a single logic level, thereby reducing the total number of logic modules used to perform the AND reduce and increasing the speed of the AND reduce.

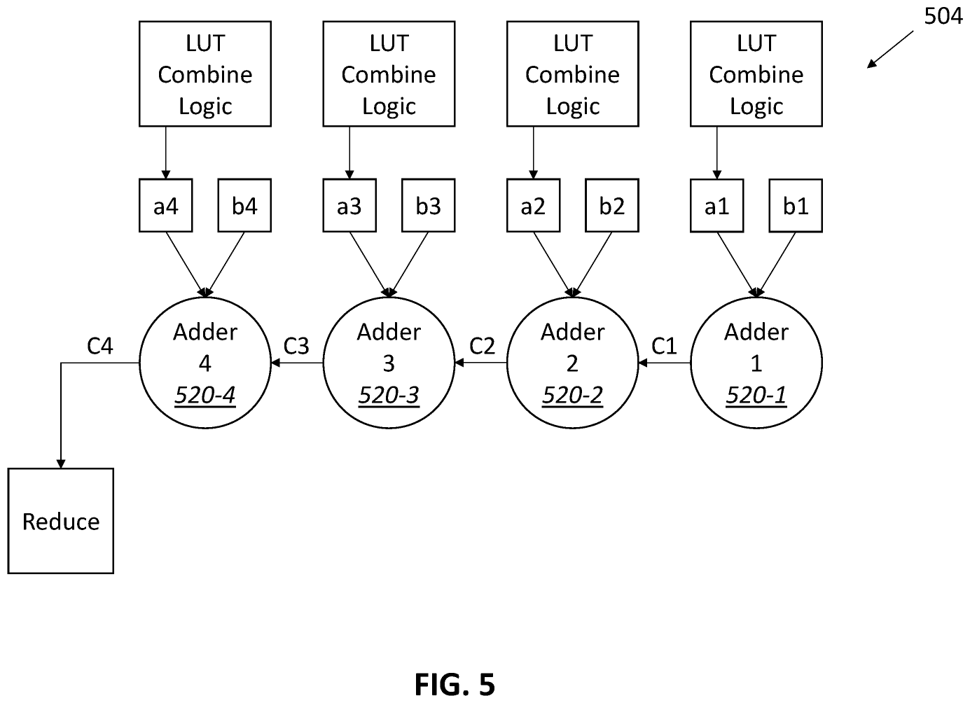

FIG. 5 is a representation of a carry chain 504 logic system, according to at least one embodiment of the present disclosure. For example, FIG. 5 illustrates an example configuration of a logic chain 504 in which the input vector includes inputs originating from any LUT combinational logic. For example, in the event that additional combinational logic is needed, the logic chain 504 may utilize the combinational logic of the LUTs and feed the output of the LUTs to the logic chain 504. This enables the logic chain 504 to include the combinational logic and the AND/OR reduce into a single logic level instead of across multiple logic levels.

An example implementation of this configuration could include a counter configured to increment or decrement based on some detected condition. In this example, a registered function could be configured and driven as an input to an adder (e.g., on the chain of adders). Where this would conventionally be performed by providing an output from a logic module of another logic layer, this framework enables feeding the carry signal as an input to the logic chain within the same logic layer and significantly reduce latency that would otherwise be caused by routing the signal via a routing fabric between logic layers. As shown in FIG. 5, this combination of any combinational logic with a framework of the reduce logic function may apply to both the AND-reduce and the OR-reduce configurations.

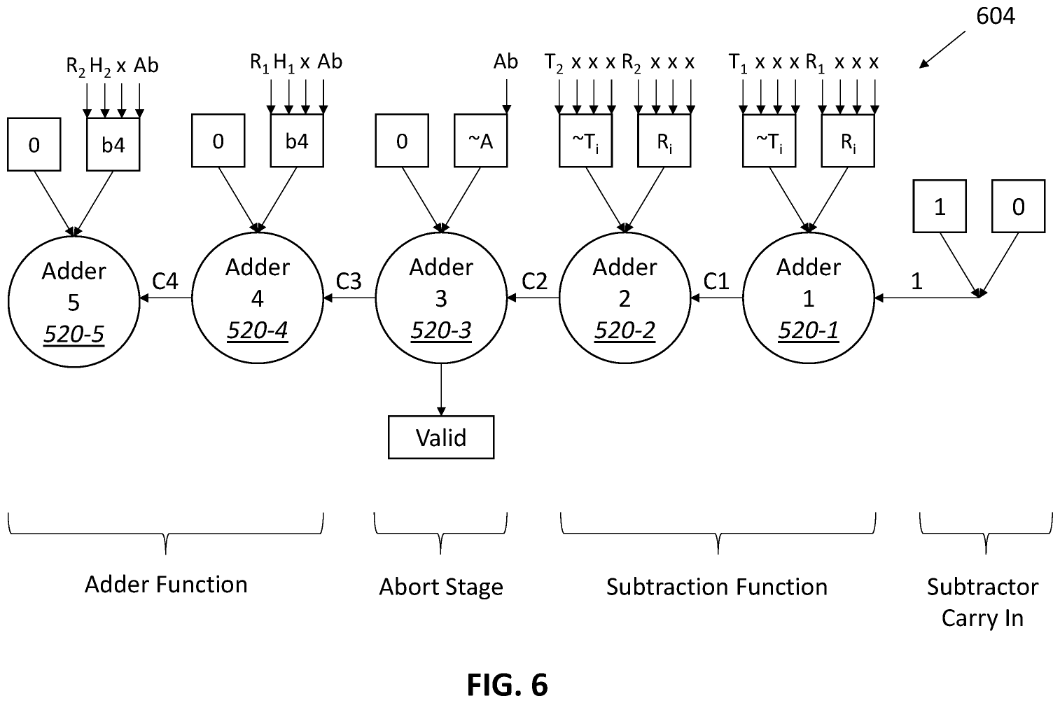

FIG. 6 illustrates another example logic chain 604 framework in accordance with one or more embodiments described herein. For example, FIG. 6 illustrates an example in which an AND/OR reduce is fed into an adder 520 (e.g., a counter). In this scenario the carry out signal may be fed from an adder 520 as the carry in value for an adder 520 of a counter.

For example, a first logic function (e.g., a subtractor function) can supply a carry out indicating the result of a compare operation. This may be provided in conjunction with a different set of combinational signals that are used to provide a carry-in value to another counter. Thus, this framework may be utilized to implement an entire logic of multiple logic functions using the carry chain configuration described herein.

As shown in FIG. 5, “T” and “R” signals may refer to two inputs that refer to pointers of a set of values (e.g., a queue of inputs having a particular order, such as inputs issued by a processor). The carry out signal may refer to a carry out of the most significant stage of the subtraction and may be combined with another signal to generate a logic function. This logic function may be fed as an input to another function. In particular, as shown in FIG. 5, the carry out signal may be used to drive additional logic of a common logic level (e.g., without routing signals via routing fabric between logic lanes).

As a general example, the illustrated example shows a first logic function (e.g., a subtraction function). The result of the logic function is fed to an abort stage (e.g., a second logic function), which is fed to an adder function (e.g., a third logic function). This implementation enables a logic chain to be implemented as a more complex function that would normally involve a multi-plexor (MUX) or other function that involves multiple logic stages that has the potential of causing an unacceptable amount of delay. Indeed, by using the carry out signal to drive additional logic functions, the configurations described herein enables a logic chain to consider multiple conditions within a single logic stage.

From a more general view, similar principles of the above examples may be implemented to combine multiple logic functions before or after a reduce logic function (e.g., AND-reduce, OR-reduce), such as before or after a subtraction function as shown in FIG. 5. Where conventional systems typically involve complex or robust combinations of logic modules across multiple logic stages, the implementations described herein enable combination of a wide variety of logic functions (including unrelated logic functions) without incurring a penalty.

Example implementations may include incrementing a queue, taking a comparison and using it as a logic function without a routing penalty, updating a read pointer, an abort function, or any other combinational logic.

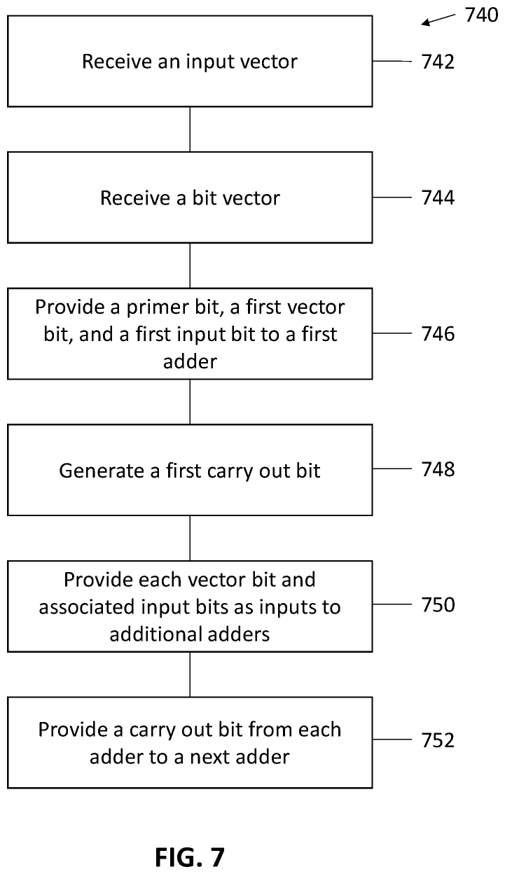

FIG. 7 is a flowchart of a method 740 implemented on programmable hardware, according to at least one embodiment of the present disclosure. The method 740 includes receiving an input vector comprising a plurality of input bits at a logic module at 742. The logic module receives a bit vector at 744. The bit vector includes a primer bit and a plurality of vector bits. The logic module provides the primer bit, a first vector bit of the plurality of vector bits, and a first input bit of the plurality of input bits to a first adder in the carry chain at 746.

The first adder generates a first carry out bit based on the primer bit, the first vector bit, and the first input bit at 748. The logic module provides each vector bit from the plurality of vector bits and an associated input bit from the plurality of input bits as inputs to additional adders in the carry chain at 750. The programmable hardware provides a carry out bit from each adder to a next adder in the carry chain to generate an output based on a last carry out bit from a last adder in the carry chain at 752.

In some embodiments, the input vector includes input values based on outputs of combinational logic from additional logic modules implemented on programmable hardware. In some embodiments, additional logic modules are implemented on the same logic level as the carry chain of logic modules. In some embodiments, the input values include carry out signals from adders of the additional logic modules.

In some embodiments, values of the bit vector are based on a configuration of the logic modules to act as a corresponding logic function. In some embodiments, the values of the bit vector include the primer bit and a set of one bit values based on the logic modules being configured to act as an AND-reduce logic function. In some embodiments, the values of the bit vector include the primer bit, a one bit value for the first vector bit, and a set of zero bit values based on the logic modules being configured to act as an OR-reduce logic function. In some embodiments, the primer bit is a one bit value.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method being implemented on a carry chain of logic modules, the method comprising:
receiving an input vector comprising a plurality of input bits;
receiving a bit vector comprising a primer bit and a plurality of vector bits;
providing the primer bit and a first input bit of the plurality of input bits to a first adder in the carry chain;
generating a first carry out bit at the first adder based on the primer bit and the first input bit;
providing each vector bit from the plurality of vector bits and an associated input bit from the plurality of input bits as inputs to additional adders in the carry chain; and
providing a carry out bit from each adder to a next adder in the carry chain to generate an output based on a last carry out bit from a last adder in the carry chain.

2. The method of claim 1, wherein the input vector includes input values based on outputs of combinational logic from additional logic modules implemented on the programmable hardware.

3. The method of claim 2, wherein the additional logic modules are implemented on a same logic level as the carry chain of logic modules.

4. The method of claim 2, wherein the input values include carry out signals from adders of the additional logic modules.

5. The method of claim 1, wherein values of the bit vector are determined based on a configuration of the logic modules to act as an associated logic function.

6. The method of claim 5, wherein the values of the bit vector include the primer bit and a set of one bit values based on the logic modules being configured to act as an AND-reduce logic function.

7. The method of claim 5, wherein the values of the bit vector include the primer bit having a one bit value and a set of zero bit values based on the logic modules being configured to act as an OR-reduce logic function.

8. The method of claim 1, wherein the primer bit is a one bit value.

9. A carry chain logic function, the carry chain logic function comprising:
a first logic module including a first adder and a second adder, the first logic module being configured to:
receive, at the first adder, a first input and a primer bit of a bit vector to generate a first carry out signal to feed to the second adder;
receive, at the second adder, the first carry out signal as a first carry in signal, a second input, and an associated second vector bit of the bit vector to generate a second carry out signal;
a second logic module including a third adder and a fourth adder, the second logic module being configured to:
receive, at the third adder, the second carry out signal as a second carry in signal, a third input, and an associated third vector bit of the bit vector to generate a third carry out signal; and
receive, at the fourth adder, the third carry out signal as a third carry in signal, a fourth input, and an associated third vector bit of the bit vector to generate a fourth carry out signal.

10. The carry chain logic function of claim 9, wherein a last carry out signal of the carry chain logic function including the first logic module and the second logic module is an output of a logic gate based on a combination of the first input, the second input, the third input, and the fourth input received by respective adders of the carry chain logic function.

11. The carry chain logic function of claim 9, wherein one or more of the first input, the second input, the third input, and the fourth input received at the first adder, the second adder, the third adder, and the fourth adder refer to outputs of combinational logic functions on a same or different logic level as the carry chain logic function.

12. The carry chain logic function of claim 9, wherein the vector bits of the bit vector are based on a particular logic function that the carry chain logic function is configured to emulate.

13. The carry chain logic function of claim 12, wherein the vector bits of the bit vector are all one values based on the carry chain logic function being implemented as an OR-reduce logic gate.

14. The carry chain logic function of claim 12, wherein the first vector bit of the bit vector is one value and remaining vector bits of the bit vector are all zero values based on the carry chain logic function being implemented as an AND-reduce logic gate.

15. A programmable hardware device, comprising:
a plurality of logic modules being programmed in a logic chain comprising a plurality of adders, the plurality of logic modules being programmed to:
receive an input bit at a first adder of the plurality of adders, the adder being located in a first logic module of the plurality of logic modules;
receive a vector bit at the first adder of the plurality of adders;
generate a carry out bit using the input bit and the vector bit at the first adder of the plurality of adders; and
provide the carry out bit to a next adder of the plurality of adders, the next adder receiving the carry out bit as a carry in bit, the next adder being in a second logic module of the plurality of logic modules.

16. The programmable hardware device of claim 15, wherein the input bit is received from a LUT in the first logic module.

17. The programmable hardware device of claim 16, wherein the LUT performs a reduce on a plurality of inputs from an input vector.

18. The programmable hardware device of claim 16, wherein the LUT performs combination logic on a plurality of inputs from an input vector.

19. The programmable hardware device of claim 15, wherein the next adder is in the same logic level as the adder.

20. The programmable hardware device of claim 15, wherein the plurality of hardware devices are programmed to provide a last carry out bit from a last adder of the plurality of adders to a reduce function.
